(19) United States
(12) Patent Application Publication
(10) Pub. No.: US 2023/0237197 A1
(43) Pub. Date: Jul. 27, 2023

(54) SYSTEMS, METHODS, AND DEVICES FOR IMPLEMENTING SECURITY PLATFORMS

(71) Applicant: GrayHeller, LLC (DBA) Appsian, San Ramon, CA (US)

(72) Inventors: Kevin Agatone, San Ramon, CA (US); Adam Wlad, San Ramon, CA (US)

(21) Appl. No.: 18/158,355

(22) Filed: Jan. 23, 2023

Related U.S. Application Data
(60) Provisional application No. 63/267,103, filed on Jan. 24, 2022.

(51) Int. Cl. G06F 21/62

(52) U.S. Cl. CPC G06F 21/629

(57) ABSTRACT

Systems, methods, and devices implement security policies in security platforms implemented across web servers and application servers. Systems include one or more processors configured to identify an application installed in an application environment, receive an input associated with the application, and generate one or more dynamic security policies associated with the application based, at least in part, on the input and one or more application components, the one or more dynamic security policies defining one or more security operations for application data objects included in the application. Systems also include a database system configured to store the plurality of dynamic security policies associated with the application.

### CROSS REFERENCE TO RELATED APPLICATIONS

This application claims the benefit of U.S. Provisional Application No. 63/267,103, filed on Jan. 24, 2022 (Atty Docket No. APPSP003P), which is incorporated by reference herein in its entirety for all purposes.

### TECHNICAL FIELD

This disclosure generally relates to security and authentication of application servers, and more specifically, to a security platform implemented in the context of such application servers.

### BACKGROUND

Applications may be executed in an online and cloud-based environment in which application servers communicate with web servers and client devices to provide the client device with application services via a communications network. Providing access to application services in such a manner may be utilized in contexts such as enterprise applications and software as a service (SaaS) platforms. Such applications may have thousands of users, each of which issuing multiple requests and incurring multiple interactions with such application servers. Accordingly, a single application may service millions of requests and events associated with such users. Conventional techniques for implementing such applications remain limited because they are not able to effectively and efficiently implement security operations dynamically and in real time for such a vast number of requests and events and in a manner that effectively and efficiently enables the prevention and reduction of the occurrence of security breaches.

Consequently, the techniques and mechanisms of the present invention provide enhanced mechanisms for effectively and efficiently implementing security mechanisms in enterprise applications and software as a service (SaaS) environments.

### BRIEF DESCRIPTION OF THE DRAWINGS

FIG. 1 illustrates an example of a system for implementing a security platform, configured in accordance with some embodiments.

FIG. 2 illustrates another example of a system for implementing a security platform, configured in accordance with some embodiments.

FIG. 3 illustrates an example of a flow chart of a method for implementing a security platform.

FIG. 4 illustrates an example of a flow chart of another method for implementing a security platform.

FIG. 5 illustrates an example of a flow chart of an additional method for implementing a security platform.

FIG. 6 illustrates another example of a flow chart of another method for implementing a security platform.

FIG. 7 illustrates an example of a processing device, configured in accordance with various embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

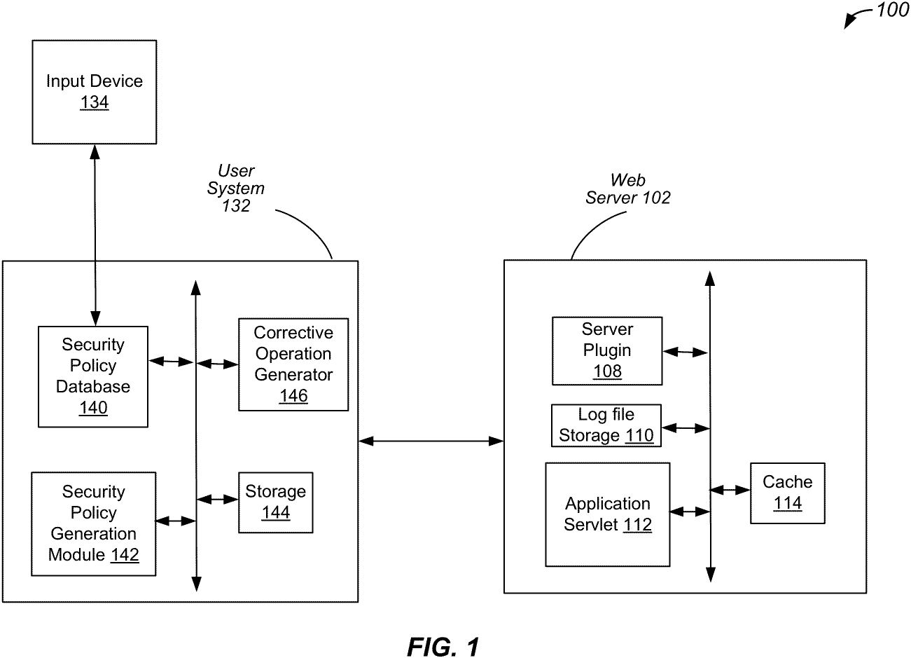

FIG. 1 illustrates an example of a system for implementing a security platform, configured in accordance with some embodiments. In various embodiments, systems, such as system 100, may be implemented to dynamically define security policies associated with application data. Systems, such as system 100, may also provide logging of data events, such as application requests, as well as the generation of security policies to apply one or more security operations associated with such data events or application data generally. Accordingly, system 100 may be implemented in the context of a distributed computing platform that may be used to implement an SaaS application. As will be discussed in greater detail below, system 100 is configured to utilize such dynamic security policies to prevent malicious behavior by automatically determining and implementing security policies to support security and corrective actions thus providing enhanced security operations in a manner that is improved in efficiency.

In various embodiments, system 100 includes input device 134 which may be a device operated by an end user. The input device may be a client machine, such as a personal computer or a mobile device such as a smartphone, and may be configured to receive one or more inputs from a user. For example, the input device may be configured to receive inputs such as keyboard strokes and mouse clicks. The input device may also include a display device configured to display a user interface screen to the user. In various embodiments, input device 134 is used to execute a portion of a cloud-based or enterprise application, such as PeopleSoft®. Accordingly, input device 134 may be configured to execute a locally installed application that communicates with one or more other components of system 100. As shown in FIG. 1, system 100 may include multiple client devices.

System 100 further includes user system 132 which is configured to facilitate communication between input device 134 and other system components, such as web server 102 discussed in greater detail below. Accordingly, user system 132 includes one or more components configured to handle requests received from input device 134, and process such requests which may be associated with an application implemented using web server 102. More specifically, user system 132 is configured to receive and monitor activity of input device 134, as well as other system components, identify malicious patterns of activity, as well as dynamically generate and implement one or more security and/or corrective policies.

Accordingly, user system 132 includes security policy generation module 142 which is configured to dynamically generate security policies for application data. As will be discussed in greater detail below, security policy generation module 142 is configured to scan configurations of application data, identify data objects and data entries that might be subject to one or more security policies, and to automatically generate one or more security policies based on such a scan and identified data objects. Examples of security policies may include access control policies, data security policies, password policies, data classification policies, data retention policies, acceptable use policies, and network security policies. According to various embodiments, access control may involve enforcing limitations and access to systems and data to authorized users. Authorized users may include those with a certain privilege level and multifactor authentication established.

In this way, security policy generation module 142 is configured to automatically and dynamically generate security policies for instances of distributed applications, and to define security operations that may be performed for sensitive data included in such instances of the distributed applications.

In some embodiments, security policy generation module 142 may be configured to dynamically generate sets of security policies for configurations of application data in response to one or more events, such as installation of an application component, or installation of an update. In some embodiments, the dynamic generation of Additional details regarding the scanning of application data and dynamic generation of security policies is discussed in greater detail below.

User system 132 also includes security policy database 140 which is configured to store security policies and associated data objects generated by security policy generation module 142. Accordingly, static and dynamic security polices as well as associated data objects and mappings, as will be discussed in greater detail below, may be stored in security policy database 140. Moreover, as will also be discussed in greater detail below, various reports and output data objects may also be stored in security policy database 140.

According to various embodiments, the security policy database 140 can be analyzed automatically to determine effective security policies for particular data objects, users, devices, etc., based on past security breaches associated with a platform and similar platforms. Security policies can be tested against real world threats as well as simulated threats and modified to balance security risks versus user experience, efficiency, simplicity, ease of management, etc.

In particular embodiments, models can be trained to implement the determinations described above. In various embodiments, such training data may be obtained from a test system in which both real world and simulated situations are implemented. Security policies can be tested and evaluated for different types of data and users. In various embodiments, the training data may be specific to the application environment, and thus may be configured to model expected behavior of users of the application as well as abnormal behavior, as may be defined by the security-related events described above which may be defined by a user or system administrator.

In various embodiments, user system 132 additionally includes storage 144 which is a storage device configured to store data generated by security policy generation module 142. Storage 144 may also be configured to store and cache information received from web server 102. In some embodiments, storage 144 may be a database system or any other suitable data storage system.

System 100 further includes web server 102 which is configured to communicate with user system 132, and is also configured to handle requests received from user system 132. Accordingly, web server 102 may be configured to communicate with user system 132 via a first communications interface and a communications network, such as the internet, and may be further configured to receive requests from user system 132 and provide responses to user system 132. In various embodiments, web server 102 includes various components configured to provide services specific to a particular application, as well as generate log files associated with such an application and enable security features based on one or more security policies. As will be discussed in greater detail below, log files may store logged events, and may be generated based, at least in part, on parameters identified by log tokens.

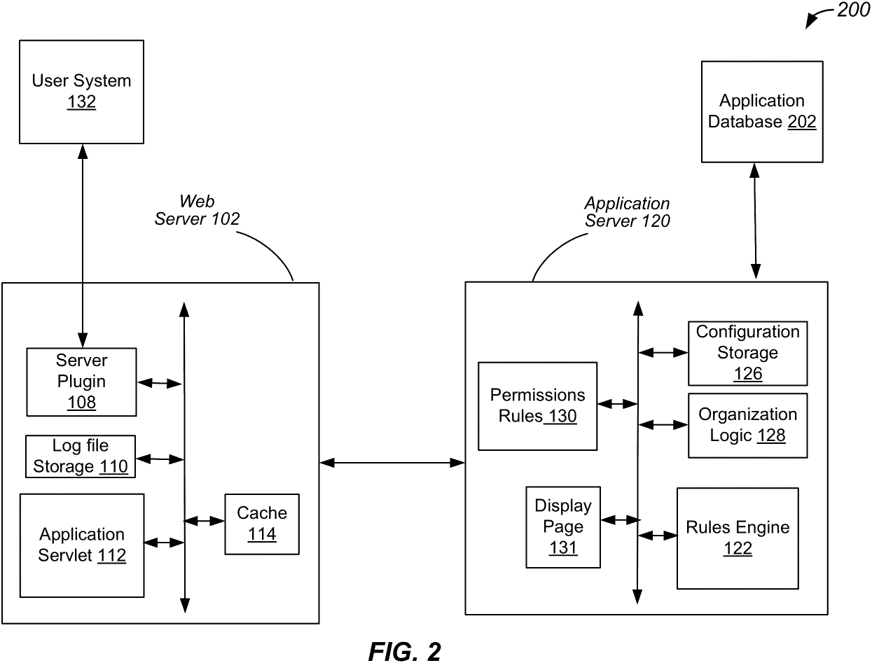

Accordingly, web server 102 includes server plugin 108 which is configured to log activity and generate log files. As shown in FIG. 1, server plugin 108 may include a logging layer is implemented between the client devices, such as input device 134, and other components of web server 102 as well as downstream components, such as an application server. Server plugin 108 is configured to handle communications with user system 132, and thus is able to track and log all activity between user system 132 and web server 102, as well as between an application server and user system 132, as will be discussed in greater detail below with reference to FIG. 2. As will also be discussed in greater detail below, server plugin 108 is further configured to track and log activity between user system 132, and other components of system 100 as well. In this way, server plugin 108 has extensive access to interactions between user system 132 and other system components used to execute and run an application.

In various embodiments, server plugin 108 is configured to enable tracking and logging that is configured based, at least in part, on native properties of the application that is being hosted. Such application properties may be particular data fields on a screen or page presented to a user, a page or location within an application hierarchy, or any suitable part of an application architecture or structure. In this way, the native structure and configuration of the application hosted by an application server, discussed in greater detail below, may be used to define parameters that are tracked, configure the generation of log files, and also configure the query of such log files and/or implementation of security operations based on such log files. As will be discussed in greater detail below, server plugin 108 is configured to enable tracking and logging that is specifically configured based on a combination of such application properties as well as hardware/client device properties.

In one example, server plugin 108 is configured to enable tracking and logging associated with particular data objects of an application that is supported by application server 120. More specifically, server plugin 108 may include a logging layer that is configured to enable the tracking and logging of particular data fields of the application, and interactions with such data fields. Accordingly, specific log files may be generated based on interactions with particular data fields, as well as additional parameters used to configure the generation of the log file, such as a user and role interacting with the data field as well as one or more other conditional parameters, such as whether or not a particular page or module was access prior to the interaction with the data field.

Furthermore, the logging of application data fields can be configured and implemented independently of how they may be represented in the encoding of the data fields that is native to the application may use. For example, custom identifiers may be generated to track and log particular data field interactions. In one example, an identifier named “Purchase Order ID” may be generated and used to log data field interactions. In this example, the native application might not have such an identifier, recognize such an identifier, or support such an identifier. Moreover, the context of an application implemented in a distributed manner that may have different client devices and display screens as well as different interactions/transactions in different industries and countries, different identifiers, such as “PO_HDR_SRCH_PO_ITEM_ID” and “PO_MASTER_PO_ITEM_ID” may be used in different parts of the application/system, and the application might not have a way to reconcile the different identifiers.

Accordingly, when an application is implemented in such a distributed environment, the different identifiers used to reference a particular data field may number into the tens or even hundreds. In this example, server plugin 108 is configured to support the representation of these different identifiers, which may be native or local identifiers, as a custom identifier “Purchase_Order_ID”, and thus enable the logging and tracking of activity associated with that data field across the various different environments and locations in which the application is implemented. Such custom identifier designations may be stored in server plugin 108, or in log file storage 110. In some embodiments, the custom identifier designations may be stored as a data object that maps the custom identifiers to the local/native identifiers. In this way, server plugin 108 is configured to handle numerous different ways of referencing a data field or data object of a distributed application, and is configured to implement logging/security operations across such a heterogenous environment. As will be discussed in greater detail below, the custom identifiers may be generated by a customer or user, or by server plugin 108.

Furthermore, server plugin 108 is configured to enable tracking and logging of the contextual environment of the application. In this way, server plugin 108 is further configured to support logging of the application environment itself. As discussed above, logging systems may allow access to environmental data such as a host name of a server and possibly operating system environment variables. However, server plugin 108 is configured to incorporate application environment information as well. Such information may include which backend application server processes a request, and which application domain is being used, as many largely distributed customers may have several application domains on a single physical server. In this way, server plugin 108 is configured to combine the tracking and logging of underlying system environmental information with application environmental information to generate an enriched set of tracked and logged environmental information.

As discussed above, the determination of types of events and information to be logged may be determined by a customer or user. In various embodiments, the determination of types of events and information to be logged may also be implemented by server plugin 108. For example, server plugin 108 may be configured to implement one or more machine learning techniques to determine types of events and information that should be logged, as well as determine when one or more actions should be taken based on such logged activity. Accordingly, server plugin 108 may be configured to identify types of log files that should be generated based on one or more environmental parameters, such as a type of application being implemented, types of users of the application, as well as a type of security concern that is to be prevented.

Moreover, server plugin 108 may be further configured to identify one or more actions to be taken based on the logged activity. For example, specific patterns of logged activity may be identified, such as an unusual number of access requests from a particular type of user to a particular type of data resource not typically associated with that type of user. In response to identifying the pattern of logged activity, server plugin 108 may determine that a particular action should be taken, such as the generation of a security notification or revocation of the user’s access.

In various embodiments, training data may be utilized to train server plugin 108 to implement the determinations described above. In various embodiments, such training data may be obtained from a test system in which system parameters and operations are simulated under normal conditions as well as conditions in which one or more security-related events is occurring, such as a brute force attack or other unauthorized access. In various embodiments, the training data may be specific to the application environment, and thus may be configured to model expected behavior of users of the application as well as abnormal behavior, as may be defined by the security-related events described above which may be defined by a user or system administrator.

Web server 102 also includes log file storage 110 which is a storage location used to store the log files generated by server plugin 108. Accordingly, log file storage 110 may be a local storage device that stores such log files in a particular manner, such as indexing logged events based on client device ID, user ID, and/or application ID.

Web server 102 further includes cache 114 which may be used to cache various configuration data about the application. Accordingly, particular configuration data may be stored in cache 114 so that it is quickly accessible to components of web server 102 as well as user system 132. In various embodiments, web server 102 also includes application servlet 112 which is configured to handle network requests for a particular application. For example, application servlet 112 may be configured to handle HTTP requests associated with the application.

FIG. 2 illustrates another example of a system for implementing a security platform, configured in accordance with some embodiments. As similarly discussed above, systems, such as system 200, include user system 132 which is communicatively coupled to web server 102. Moreover, web server 102 includes various components such as server plugin 108, log file storage 110, application servlet 112 and cache 114. As will be discussed in greater detail below, user system 132 and web server 102 are communicatively coupled to application server 120 which may be configured to host a distributed application that is part of a SaaS platform.

Accordingly, system 200 includes application server 120 which is configured to provide various services associated with the application. For example, application server 120 is configured to host components of an application, and create a server environment configured for the application. Accordingly, application server 120 is configured to run various components of an application utilized by input device 134 and user system 132 where such an application is a cloud-based application, an enterprise application, or provided as software as an SaaS application.

Application server 120 includes permissions rules engine 130 which is configured to manage and define permissions associated with the application. Accordingly, permissions rules engine 130 may be a processing device that is configured to store and maintain rules used to define classes of users, as well as permissions and access levels associated with such classes of users. Application server 120 also includes rules engine 122 which may be a processing device that is configured to store and maintain rules associated with the evaluation and storage of data. Accordingly, rules engine 122 is configured to store and maintain rules that underly the storage and retrieval of data from database 140 discussed in greater detail below.

Application server 120 further includes configuration storage 126 which is configured to store configuration data, such as that discussed above with reference to cache 114. Application server 120 also includes display page 131 which is configured to generate web pages for display on a device or machine, such as input device 134. Accordingly, such generation of display pages may be configured based on one or more aspects of input device 134, such as a resolution or size of a display of input device 134. Application server 120 additionally includes organization logic 128 includes rules that define data objects and process flows underlying the application. Accordingly, rules underlying the processes and workflows discussed in greater detail below may be stored in organization logic 128.

System 100 further includes application database 202 which may be a database system configured to store application data for the application. Accordingly, database 202 is communicatively coupled with application server 120, and is configured to store application data which may be user data, as well as various other configuration data. In various embodiments, database 202 may be a distributed file system, a clustered storage system, or any other suitable storage system. Moreover, database 202 may be a multitenant database system that supports multiple tenants of a particular application, or multiple applications.

While various embodiments of system 100 have been discussed above, it will be appreciated that various additional embodiments are contemplated herein. For example, system 100 may include multiple client devices, multiple web servers, multiple application servers, and multiple databases. Moreover, web server 102 may be configured to support multiple different applications, and additional instances of application servlets. In this way, system 100 may support multiple enterprise applications, and tracked and logged information may be obtained from multiple enterprise applications.

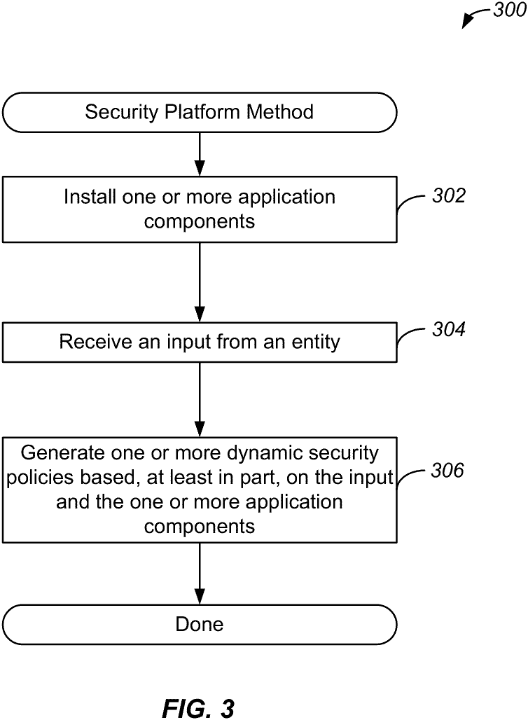

FIG. 3 illustrates an example of a flow chart of a method for implementing a security platform. As will be discussed in greater detail below, a method, such as method 300, may be performed to, at least in part, automatically generate security policies for one or more components of an application. Accordingly, automatic security policy generation may be implemented as part of an application product installation and/or configuration process.

Method 300 may perform operation 302 during which one or more application components may be installed. In various embodiments, the one or more application components may be application code for an application, such as a distributed application. Accordingly, application code may be installed as part of an installation process of a distributed or hosted application. In some embodiments, an application component may be an update to an already installed application. Accordingly, the application component may be a data object, such as a software patch.

Method 300 may perform operation 304 during which an input may be received. In various embodiments, the input may be received from an entity, such as a user or administrator. The input may be received via an input device, and may be a click or entry of data into one or more data fields. In various embodiments, the input may identify that one or more security policies should be generated for the application. As disclosed herein, a policy may be a configuration of an application that is configured to implement one or more security functionalities. As will be discussed in greater detail below, the generation of such security policies may be, at least in part, automated.

Method 300 may perform operation 306 during which one or more dynamic security policies may be generated. As will be discussed in greater detail below, configurations and components of application data may be scanned, and one or more security policies may be automatically generated based, at least in part, on a result of such scanning. As will also be discussed in greater detail below, such security policies may include the implementation of security operations such as data masking, or the implementation of authentication or validation policies. Accordingly, during operation 306, particular types of data objects may be identified, and dynamic security policies may be generated based on properties of the data objects.

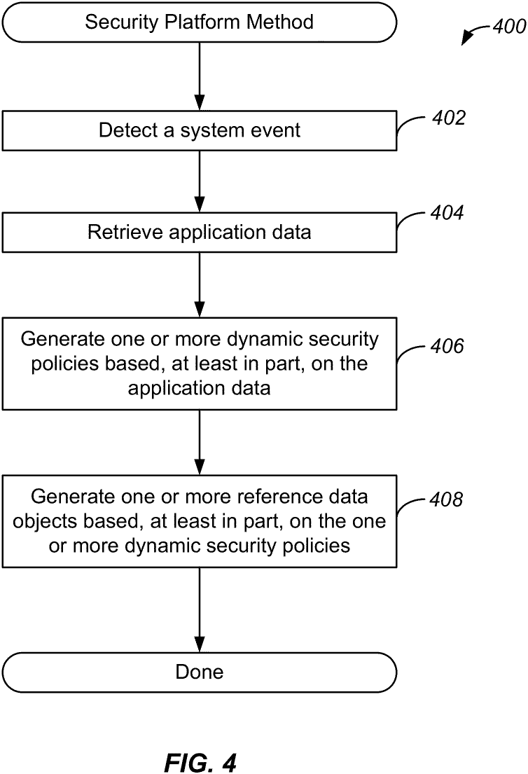

FIG. 4 illustrates an example of a flow chart of another method for implementing a security platform. As will be discussed in greater detail below, a method, such as method 400, may be performed to, at least in part, automatically generate security policies for one or more components of an application. Accordingly, automatic security policy generation may be implemented based on a deep scan of one or more application configurations as well as other existing policy information.

Method 400 may perform operation 402 during which a system event may be detected. As similarly discussed above, the system event may be an input that may be received from an entity, such as a user or administrator. The input may be received via an input device, and may be a click or entry of data into one or more data fields. As also discussed above, the input may identify that one or more security policies should be generated for the application. In some embodiments, the system event may be an action or operation performed by another system component. For example, the system event may be one or more operations performed by an application installer, or an application servlet associated with the application installer.

Method 400 may perform operation 404 during which application data may be retrieved. Accordingly, during operation 404, various data structures of an application may be queried to obtain information about application data objects and data structures, as well as associated data tags. In some embodiments, such data tags may be configured to specify one or more properties associated with such application data objects. In one example, a data tag may be a condition tag that identifies one or more parameters, such as security parameters, dependency parameters, exclusion parameters, and/or redaction parameters.

Method 400 may perform operation 406 during which one or more dynamic security policies may be generated. As will be discussed in greater detail below, configurations and components of application data may be scanned, and one or more security policies may be automatically generated based, at least in part, on a result of such scanning. More specifically, one or more scans may be completed to identify sensitive data and where such sensitive data is stored, and one or more security policies may be dynamically defined for such sensitive data. As will be discussed in greater detail below, the generation and application of such security policies may include the overriding of existing data object properties, the addition or removal of data object properties, as well as the generation of custom data tags or properties.

Method 400 may perform operation 408 during which one or more reference data objects may be generated. In various embodiments, a reference data object may be a data object, such as a report, that provides a summary of the dynamic security policies that have been generated. Accordingly, one or more data objects may be created to maintain a history of dynamic policies generated, and changes made to application data objects. In various embodiments, the reference data object may be included in a message that is sent to another system component. Accordingly, a report may be viewed by an entity, such as a user or an administrator, at an input device.

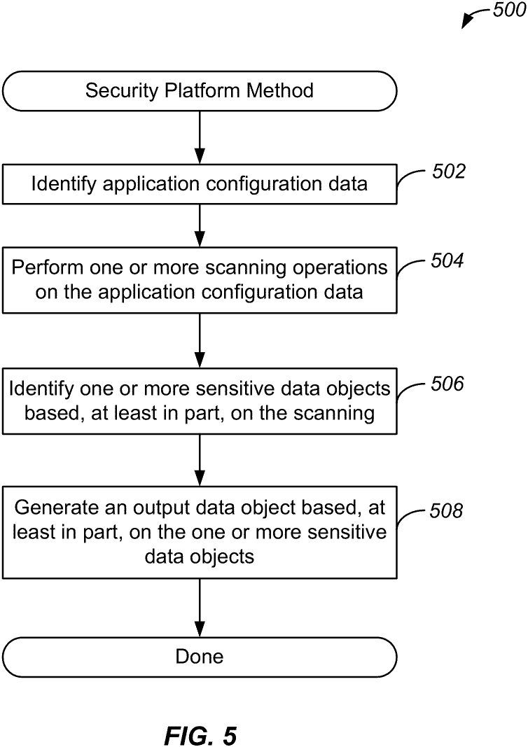

FIG. 5 illustrates an example of a flow chart of yet another method for implementing a security platform. As will be discussed in greater detail below, a method, such as method 500, may be performed to, at least in part, automatically generate security policies for one or more components of an application. Accordingly, automatic security policy generation may be implemented based on scanning operations used to identify sensitive data within the application components.

Method 500 may perform operation 502 during which application configuration data may be identified. In various embodiments, the application configuration may be configuration data for a particular application that configures and devices an application environment of the application. Accordingly, the application configuration data may include configuration parameters that define properties of data objects within the application, as well as relationships and dependencies between data objects, as well as other data objects or applications external to the application for which the application configuration data is being identified.

Method 500 may perform operation 504 during which one or more scanning operations may be performed. Accordingly, during operation 504 the application data objects may be scanned to identify data objects having one or more designated parameters. Accordingly, one or more system components may scan different layers of the application as well as data objects included within such layers of the application to perform a complete scan of all application data. As will be discussed in greater detail below, the scanning operations may be performed to parse and scan different data objects in different locations of an application or application configuration data to determine if sensitive data is present.

Method 500 may perform operation 506 during which one or more sensitive data objects may be identified. As will be discussed in greater detail below, sensitive data objects may be types of data objects for which one or more security policies should be defined and/or one or more security operations should be performed. For example, data fields, such as fields and rows of data tables, may be scanned for one or more identifiers identifying a designated type of data object. In one example, such a designated type of data object may be a data entry, such as a number, having a one or more defined sensitivity parameters. For example, a number, such as a credit card number or a social security number may be identified as adhering to a particular format, or having been generated by an external algorithm, such as a cryptographic algorithm, and thus may be identified as sensitive data. In various embodiments, the sensitive data may be stored in a data structure that includes identifiers identifying the sensitive data entry, identifying a storage location of the sensitive data entry.

Method 500 may perform operation 508 during which an output data object is generated based, at least in part, on the identified one or more sensitive data objects. In various embodiments, the output data object may define parameters of an update to an application or a configuration that may be made based on the application of a security policy. In this way, the output data object may be a data structure that defines or guides the application of one or more security policies.

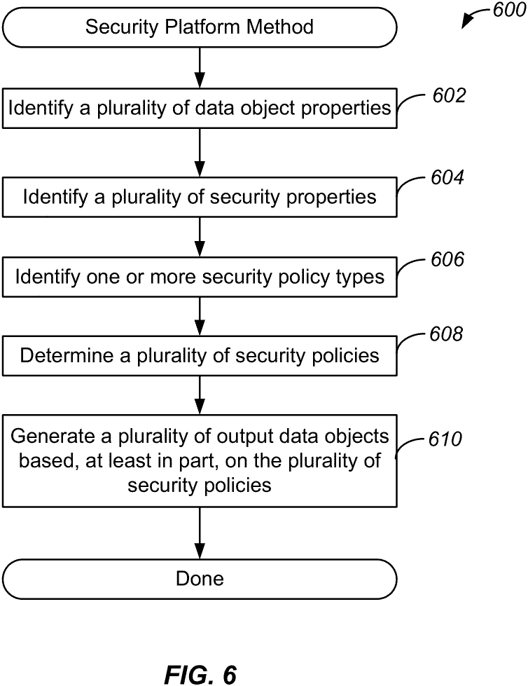

FIG. 6 illustrates an example of a flow chart of an additional method for implementing a security platform. As will be discussed in greater detail below, a method, such as method 400, may be performed to, at least in part, automatically generate security policies for one or more components of an application. Accordingly, automatic security policy generation may be implemented based on a deep scan of one or more application configurations as well as other existing policy information.

Method 600 may perform operation 602 during which a plurality of data object properties may be identified. In some embodiments, application data may be scanned in response to receiving an input, as discussed above. In various embodiments, the data object properties may also be referred to as conditions, that may be identifiers or flags that determine if the data object should be included in the application of a security policy. In some embodiments, the data object properties may be stored in data tags. In various embodiments, dependency information between conditions may also be identified. For example, if one condition may be an input to another, as may be defined based on dependency information of their associated data objects, such information may be stored in a data object.

Method 600 may perform operation 604 during which a plurality of security properties may be determined. Accordingly, one or more security properties may be identified based on the plurality of data object properties. More specifically, particular types of conditions may be mapped to particular tags identifying a specific type of data protection. For example, a particular type of data object and associated property or condition may be mapped to a particular type of data protection operation based on a designated mapping. As similarly discussed above, a sensitive number may be mapped to a data masking operation.

Method 600 may perform operation 606 during which one or more policy types may be identified. Accordingly, one or more security policy types may be identified based, at least in part, on the specified types of data protections. Accordingly, the data protection types defined in operation 604 may be mapped to particular security policy types based on a designated mapping that may have been previously defined by and entity, such as an administrator or developer. In this way, as similarly discussed above, the security policy types may be determined dynamically, and may identify one or more types of security operations to be performed on data objects discussed above with reference to operation 602, that may be sensitive data objects.

Method 600 may perform operation 608 during which a plurality of security policies may be determined. Accordingly, during operation 608, specific implementations of security policies may be determined based in the identified security policy types. In this way, specific implementations of the security policy types may be generated that identify specific security operations to be performed on the data objects. For example, a security policy type may identify a masking operation, and dynamic security policy may be generated to specifically identify masking operations performed on particular data objects. In various embodiments, multiple security policy types may be identified, and during operation 608, all possible security policies may be generated and stored as a dynamic security policy set.

Method 600 may perform operation 610 during which a plurality of output data objects may be generated. In various embodiments, the output data objects may be data objects capable of being exported to one or more other system components in one or more different formats. For example, a first output data object may be generated that identifies condition dependencies, a second output data object may be generated that identifies a grouping or sub-grouping of associated entities, such as users or organizations, that share security requirements, also referred to herein as a cohort, and a third output data object may be generated that identifies one or more condition exclusion properties.

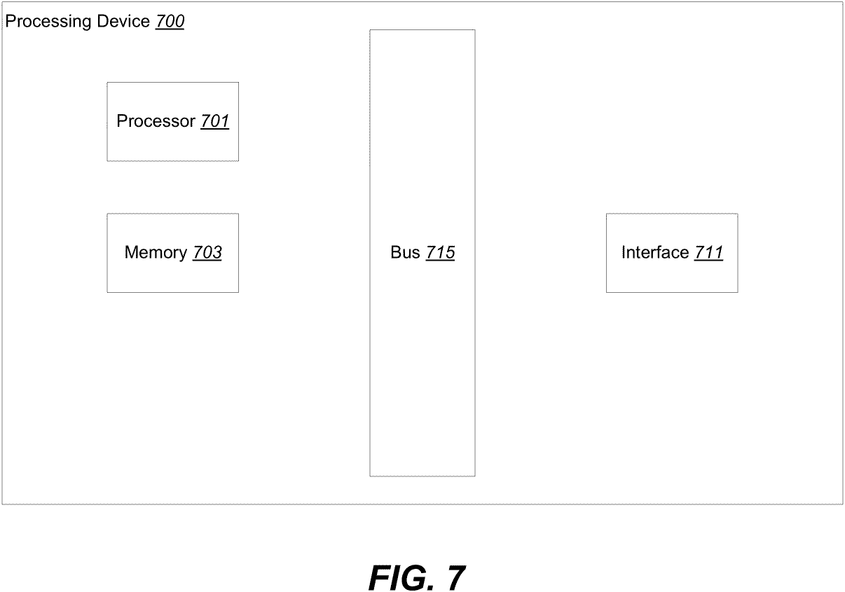

FIG. 7 illustrates an example of a processing device, configured in accordance with various embodiments. For instance, the processing device 700 can be used to implement one or more components of servers and user systems according to various embodiments described above. In addition, the processing device 700 shown can represent a processing device on a mobile device or on a traditional computer or laptop, etc. According to particular example embodiments, a device 700 suitable for implementing particular embodiments of the present invention includes a processor 701, a memory 703, an interface 711, and a bus 715 (e.g., a PCI bus). The interface 711 may include separate input and output interfaces, or may be a unified interface supporting both operations. When acting under the control of appropriate software or firmware, the processor 701 is responsible for such tasks such as the identification and generation of malicious patterns and corrective actions, as well as the generation of security policies. Various specially configured devices can also be used in place of a processor 701 or in addition to processor 701. The complete implementation can also be done in custom hardware. The interface 711 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the device 700 uses memory 703 to store data and program instructions and maintain a local side cache. The program instructions may control the operation of an operating system and/or one or more applications, for example. The memory or memories may also be configured to store received metadata.

Because such information and program instructions may be employed to implement the systems/methods described herein, the present embodiments relate to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A system comprising:
one or more processors configured to:
identify an application installed in an application environment;
receive an input associated with the application;
generate one or more dynamic security policies associated with the application based, at least in part, on the input and one or more application components, the one or more dynamic security policies defining one or more security operations for application data objects included in the application, wherein one or more dynamic security policies include access control policies tested against real world and simulated environments; and
a database system configured to store the one or more dynamic security policies associated with the application.

2. The system of claim 1, wherein the application is a distributed application hosted by an application server.

3. The system of claim 1, wherein the input is received from a client device, and the one or more dynamic security policies are generated responsive to receiving the input.

4. The system of claim 1, wherein the one or more processors are further configured to:
generate a plurality of dynamic security policies based, at least in part, on an identified data object type.

5. The system of claim 4, wherein each of the plurality of dynamic security policies is associated with a different security operation.

6. The system of claim 1, wherein the one or more processors are further configured to:
generate one or more reference data objects based, at least in part, on the one or more dynamic security policies.

7. The system of claim 1, wherein the one or more processors are further configured to:
identify a plurality of sensitive data objects in application data associated with the application; and
generate one or more output data objects based, at least in part, on identified plurality of sensitive data objects.

8. The system of claim 7, wherein the plurality of sensitive data objects is identified based, at least in part, on data properties stored as data tags.

9. The system of claim 1, wherein the one or more security operations is selected from a group consisting of a masking operation, a redaction operation, and a deletion operation.

10. A method comprising:
identifying, using one or more processors, an application installed in an application environment;
receiving, using the one or more processors, an input associated with the application; and
generating, using the one or more processors, one or more dynamic security policies associated with the application based, at least in part, on the input and one or more application components, the one or more dynamic security policies defining one or more security operations for application data objects included in the application wherein one or more dynamic security policies include access control policies tested against real world and simulated environments.

11. The method of claim 10, wherein the input is received from a client device, and the one or more dynamic security policies are generated responsive to receiving the input.

12. The method of claim 10 further comprising:
generating a plurality of dynamic security policies based, at least in part, on an identified data object type.

13. The method of claim 10 further comprising:
generating one or more reference data objects based, at least in part, on the one or more dynamic security policies.

14. The method of claim 10 further comprising:
identifying a plurality of sensitive data objects in application data associated with the application; and
generating one or more output data objects based, at least in part, on identified plurality of sensitive data objects.

15. The method of claim 14, wherein the plurality of sensitive data objects is identified based, at least in part, on data properties stored as data tags.

16. A device comprising:
a first communications interface communicatively coupled to a client device;
a processing device comprising one or more processors configured to:
identify an application installed in an application environment;
receive an input associated with the application;
generate one or more dynamic security policies associated with the application based, at least in part, on the input and one or more application components, the one or more dynamic security policies defining one or more security operations for application data objects included in the application wherein one or more dynamic security policies include access control policies tested against real world and simulated environments.

17. The device of claim 16, wherein the input is received from a client device, and the one or more dynamic security policies are generated responsive to receiving the input.

18. The device of claim 16, wherein the processing device is further configured to:
generate a plurality of dynamic security policies based, at least in part, on an identified data object type.

19. The device of claim 16, wherein the processing device is further configured to:
generate one or more reference data objects based, at least in part, on the one or more dynamic security policies.

20. The device of claim 16, wherein the processing device is further configured to:
identify a plurality of sensitive data objects in application data associated with the application; and
generate one or more output data objects based, at least in part, on identified plurality of sensitive data objects.
